(19) United States
(12) Patent Application Publication
(10) Pub. No.: US 2008/0165685 A1
(43) Pub. Date: Jul. 10, 2008

(54) Methods, systems, and computer program products for managing network bandwidth capacity

(76) Inventors: Walter Weiss, Douglasville, GA (US); Troy Meuninck, (US)

Correspondence Address: CANTOR COLBURN LLP - BELLSOUTH, 20 Church Street, 22nd Floor, Hartford, CT, 06103, US

(21) Appl. No.: 11/651,178

(22) Filed: Jan. 9, 2007

(51) Int. Cl. G01R 31/08

(52) U.S. Cl. 370/231

(57) ABSTRACT

Managing the bandwidth capacity of a network that includes a plurality of traffic destinations, a plurality of nodes, and a plurality of node-to-node links. For each of a plurality of traffic classes including at least a higher priority class and a lower priority class, an amount of traffic sent to each of the plurality of traffic destinations is determined. One or more nodes are disabled, or one or more node-to-node links are disabled. For each of the plurality of traffic classes, a corresponding traffic route to each of the plurality of traffic destinations and not including the one or more disabled nodes or disabled node-to-node links is determined. Bandwidth capacities for each of the corresponding traffic routes are determined to ascertain whether or not sufficient bandwidth capacity is available to route each of the plurality of traffic classes to each of the plurality of traffic destinations.

### BACKGROUND

The present disclosure relates generally to communications networks and, more particularly, to methods, systems, and computer program products for managing network bandwidth capacity.

Essentially, bandwidth capacity management is a process for maintaining a desired load balance among a group of elements. In the context of a communications network, these elements may include a plurality of interconnected routers. A typical communications network includes edge routers as well as core routers. Edge routers aggregate incoming customer traffic and direct this traffic towards a network core. Rules governing capacity management for edge routers should ensure that sufficient network resources are available to terminate network access circuits, and that sufficient bandwidth is available to forward incoming traffic towards the network core.

Core routers receive traffic from any of a number of edge routers and forward this traffic to other edge routers. In the event of a failure in the network core, traffic routing patterns will change. Due to these changes, observed traffic patterns are not a valid indication for determining the capacities of core routers. Instead, some form of modeling must be implemented to determine router capacity requirements during failure scenarios. These failure scenarios could be loss of a network node, loss of a route from a routing table, loss of a terminating node such as an Internet access point or a public switched telephone network (PSTN) gateway, or any of various combinations thereof. In the event of a terminating node failure, not only does this failure cause traffic to change its path, but the destination of the traffic is also changed.

Traffic flow in a communications network may be facilitated through the use of Multi-Protocol Label Switching (MPLS) to forward packet-based traffic across an IP network. Paths are established for each of a plurality of packets by applying a tag to each packet in the form of an MPLS header. This tag eliminates the need for a router to look up the address of a network node to which the packet should be forwarded, thereby saving time. At each of a plurality of hops or nodes in the network, the tag is used for forwarding the packet to the next hop or node. This tag eliminates the need for a router to look up a packet route using IP V4 route lookup, thereby providing faster packet forwarding throughout a core area of the network not proximate to any external network. MPLS is termed “multi-protocol” because MPLS is capable of operating in conjunction with internet protocol (IP), asynchronous transport mode (ATM), and frame relay network protocols. In addition to facilitating traffic flow, MPLS provides techniques for managing quality of service (QoS) in a network.

As a general consideration, bandwidth capacity management for a communications network may be performed by collecting packet headers for all traffic that travels through the network. The collected packet headers are stored in a database for subsequent off-line analysis to determine traffic flows. This approach has not yet been successfully adapted to determine traffic flows in MPLS IP networks. Moreover, this approach requires extensive collection of data and development of extensive external systems to store and analyze that data. In view of the foregoing, what is needed is an improved technique for managing the bandwidth capacity of a communications network which does not require extensive collection, storage, and analysis of data.

### SUMMARY

Embodiments include methods, devices, and computer program products for managing the bandwidth capacity of a network that includes a plurality of traffic destinations, a plurality of nodes, and a plurality of node-to-node links. For each of a plurality of traffic classes including at least a higher priority class and a lower priority class, an amount of traffic sent to each of the plurality of traffic destinations is determined. One or more nodes are disabled, or one or more node-to-node links are disabled. For each of the plurality of traffic classes, a corresponding traffic route to each of the plurality of traffic destinations and not including the one or more disabled nodes or disabled node-to-node links is determined. Bandwidth capacities for each of the corresponding traffic routes are determined to ascertain whether or not sufficient bandwidth capacity is available to route each of the plurality of traffic classes to each of the plurality of traffic destinations.

Embodiments further include computer program products for implementing the foregoing methods.

Additional embodiments include a system for managing the bandwidth capacity of a network that includes a traffic destination, a plurality of nodes, and a plurality of node-to-node links. The system includes a monitoring mechanism for determining an amount of traffic sent to the traffic destination for each of a plurality of traffic classes including at least a higher priority class and a lower priority class. A disabling mechanism capable of selectively disabling one or more nodes or one or more node-to-node links is operably coupled to the monitoring mechanism. A processing mechanism capable of determining a corresponding traffic route to the traffic destination for each of the plurality of traffic classes is operatively coupled to the disabling mechanism and the monitoring mechanism. The corresponding traffic route does not include the one or more disabled nodes or disabled node-to-node links. The monitoring mechanism determines bandwidth capacities for each of the corresponding traffic routes, and the processing mechanism ascertains whether or not sufficient bandwidth capacity is available to route each of the plurality of traffic classes to the traffic destination.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram depicting an illustrative network for which bandwidth capacity management is to be performed.

FIG. 2 is a block diagram depicting an illustrative traffic flow for the network of FIG. 1.

FIG. 3 is a flowchart setting forth illustrative methods for managing the bandwidth capacity of a network.

FIG. 4 is a block diagram showing an illustrative communications network on which the procedure of FIG. 3 may be performed.

FIG. 5 is a first illustrative network topology matrix which may be used to facilitate performance of the procedure of FIG. 3.

FIG. 6 is an illustrative network demand matrix which may be used to facilitate performance of the procedure of FIG. 3.

FIG. 7 is a first illustrative path selection matrix which may be populated using the procedure of FIG. 3.

FIG. 8 is an illustrative path cost matrix which may be populated using the procedure of FIG. 3.

FIG. 9 is a first illustrative network link demand matrix which may be populated using the procedure of FIG. 3.

FIG. 10 is a second illustrative network topology matrix which may be used to facilitate performance of the procedure of FIG. 3.

FIG. 11 is a second illustrative path selection matrix which may be populated using the procedure of FIG. 3.

FIG. 12 is a second illustrative network link demand matrix which may be populated using the procedure of FIG. 3.

FIG. 13 is an illustrative sample utilization graph showing bandwidth utilization as a function of time for the communications network of FIG. 4.

The detailed description explains exemplary embodiments of the invention, together with advantages and features, by way of example with reference to the drawings.

### DETAILED DESCRIPTION OF EXEMPLARY EMBODIMENTS

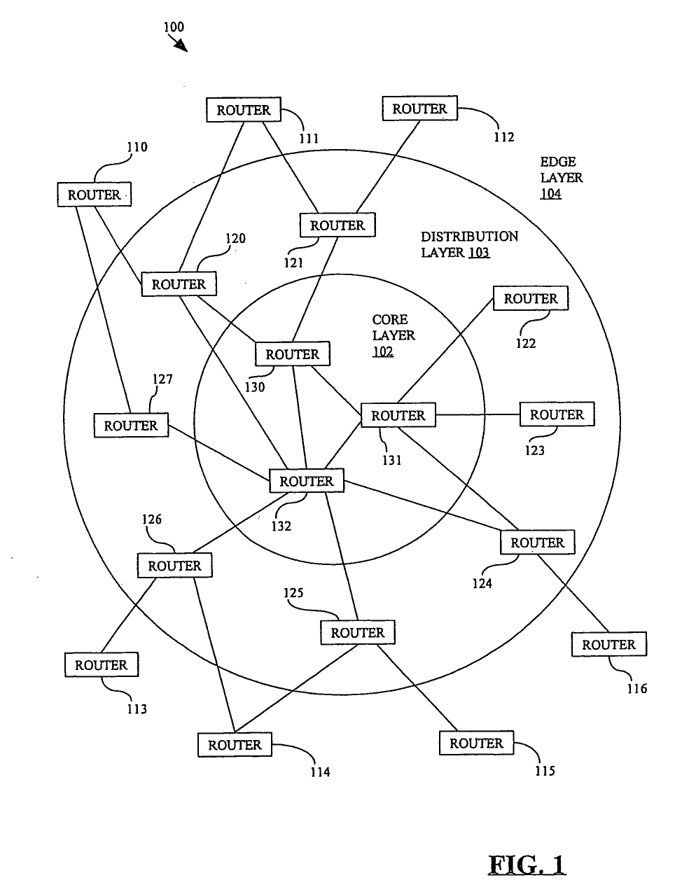

FIG. 1 is an architectural block diagram setting forth an illustrative network 100 for which bandwidth capacity management is to be performed. Network 100 includes a plurality of interconnected routers 110-116, 120-127 and 130-132 organized into a core layer 102, a distribution layer 103, and an edge layer 104. Network 100 may, but need not, be capable of implementing Multi-Protocol Label Switching (MPLS). Edge layer 104 includes routers 110-116, distribution layer 103 includes routers 120-127, and core layer 102 includes routers 130-132. Routers 110-116, 120-127 and 130-132 may be implemented using any device that is capable of forwarding traffic from one point to another. This traffic may take the form of one or more packets. The router to router interconnections of FIG. 1 are shown for illustrative purposes only, as not all of these connections are required, and connections in addition to those shown in FIG. 1 may be provided. Moreover, one or more of core layer 102, distribution layer 103, or edge layer 104 may include a lesser or greater number of routers than shown in FIG. 1. Illustratively, routers 110-116 may include customer edge (CE) routers, provider edge (PE) routers, or various combinations thereof. By way of example, routers 120-127 and 130-132 may include provider (P) routers.

Illustratively, routers 110-116, 120-127 and 130-132 each represent a node of network 100. Routers 110-116, 120-127 and 130-132 are programmed to route traffic based on one or more routing protocols. More specifically, a cost parameter is assigned to each of a plurality of router to router paths in network 100. Traffic is routed from a source router to a destination router by comparing the relative cost of routing the traffic along each of a plurality of alternate paths from the source router to the destination router and then routing the traffic along the lowest cost path. For example, assume that the source router is router 112 and the destination router is router 114. A first possible path includes routers 121, 130, 132 and 125, whereas a second possible path includes routers 121, 130, 132 and 126.

The total cost of sending traffic over the first possible path may be determined by summing the costs of sending traffic over a sequence of router to router links including a first link between routers 112 and 121, a second link between routers 121 and 130, a third link between routers 130 and 132, a fourth link between routers 132 and 125, and a fifth link between routers 125 and 114. Similarly, the total cost of sending traffic over the second possible path may be determined by summing the costs of sending traffic over a sequence of router to router links including the first link between routers 112 and 121, the second link between routers 121 and 130, the third link between routers 130 and 132, the fourth link between routers 132 and 126, and a sixth link between routers 126 and 114.

If the total cost of sending the traffic over the first possible path is less than the total cost of sending the traffic over the second possible path, then traffic will default to the first possible path. However, if the total cost of sending traffic over the first possible path is substantially equal to the total cost of sending traffic over the second possible path, then the traffic will share the first possible path and the second possible path. In the event of a failure along the first possible path, network 100 will determine another route for the traffic. Accordingly, traffic flows are deterministic based on current network 100 topology. As this topology changes, network traffic flow will also change.

As stated previously, network 100 includes edge layer 104, distribution layer 103, and core layer 102. Routers 110-116 of edge layer 104 aggregate edge traffic received from a plurality of network 100 users. This edge traffic, including a plurality of individual user data flows, is aggregated into a composite flow which is then sent to distribution layer 103. More specifically, routers 110-116 receive traffic from a plurality of user circuits and map these circuits to a common circuit for forwarding the received traffic towards distribution layer 103. Routers 120-127 of distribution layer 103 distribute traffic received from edge layer 104. Distribution layer 103 distributes traffic among one or more routers 110-116 of edge layer 104 and forwards traffic to one or more routers 130-132 of core layer 102. If distribution layer 103 receives traffic from a first router in edge layer 104 such as router 110, but this traffic is destined for a second router in edge layer 104 such as router 111, then this traffic is forwarded to core layer 102. In some cases, “local” traffic may be routed locally by an individual router in edge layer 104 but, in general, most traffic is sent towards distribution layer 103. Distribution layer 103 aggregates flows from multiple routers in edge layer 104. Depending upon the desired destination of the aggregated flow, some aggregated flows are distributed to edge layer 104 and other aggregated flows are distributed to core layer 102.

Links between edge layer 104 and distribution layer 103 are shown as lines joining any of routers 110-116 with any of routers 120-127. Links between distribution layer 103 and core layer 102 are shown as lines joining any of routers 120-127 with any of routers 130-132. In general, the bandwidths of the various router-to-router links shown in network 100 are not all identical. Some links may provide a higher bandwidth relative to other links. Links between edge layer 104 and user equipment may provide a low bandwidth relative to links between edge layer 104 and distribution layer 103. Links between distribution layer 103 and core layer 102 may provide a high bandwidth relative to links between edge layer 104 and distribution layer 103.

The various link bandwidths provided in the configuration of FIG. 1 are analogous to vehicular traffic flow in a typical suburban subdivision. Within a subdivision, various local streets having a 15 mile-per-hour (MPH) or 25 MPH speed limit are provided to link neighboring houses. Two or three of these local streets lead to a main road having a speed limit of 40 or 45 MPH. The main road leads to an on-ramp of an Interstate highway where the speed limit is 65 MPH. If an individual wants to travel to a neighboring residence, he or she would not normally get on the interstate. A similar concept applies to traffic on network 100, in the sense that high bandwidth links between core layer 102 and distribution layer 103 (analogous to an Interstate highway) should not be utilized to carry traffic between two user devices connected to the same router 110-116 of edge layer 104.

The value of the foregoing traffic flow model is based on the fact that not all users wish to send a packet over network 100 at exactly the same time. Moreover, even if two users do send packets out at exactly the same time, this is not a problem because traffic is moving faster as one moves from edge layer 104 to distribution layer 103 to core layer 102. In general, it is permissible to delay traffic for one user connected to edge layer 104 by several microseconds if this is necessary to process other traffic in core layer 102 or distribution layer 103. Since the bandwidth of core layer 102 is greater than the bandwidth of edge layer 104, one could simultaneously forward traffic from a plurality of different users towards core layer 102.

In situations where traffic from a plurality of users is to be routed using network 100, capacity planning issues may be considered. Capacity planning determines how much bandwidth capacity must be provisioned in order to ensure that all user traffic is forwarded in a timely manner. Timely forwarding is more critical to some applications than to others. For example, an FTP file transfer can tolerate more delay than a voice over IP (VoIP) phone call. In order to ensure that no traffic is adversely impacted, one needs to have the capability of forwarding all traffic as soon as it arrives or, alternatively, one must utilize a mechanism capable of differentiating between several different types of traffic. In the first instance, network 100 would need to provide enough bandwidth to satisfy all users all of the time. In reality, all users would not simultaneously demand access to all available bandwidth, so there would be large blocks of time where bandwidth utilization is very low and very few blocks of times when bandwidth utilization is high.

Information concerning network 100 utilization is gathered over time, whereupon a usage model is employed to predict how much bandwidth is necessary to satisfy all user requests without the necessity of maintaining one bit of available bandwidth in the core for one bit of bandwidth sold on the edge. This aspect of bandwidth management determines an optimal amount of bandwidth required to satisfy customer needs. Illustratively, sample data may be gathered over 5 to 15 minute intervals to base bandwidth management on an average utilization of network 100. During these intervals, it is possible that bandwidth utilization may rise to 100 percent or possibly more. If the available bandwidth is exceeded, it is probably a momentary phenomenon, with any excess packets queued for forwarding or discarded.

If a packet is dropped due to excessive congestion on network 100, it can be retransmitted at such a high speed that a user may not notice. However, if bandwidth utilization rises to 100 percent or above too frequently, the packet may need to be retransmitted several times, adversely impacting a network user. If the packet represents VoIP traffic, it is not useful to retransmit the packet because the traffic represents a real time data stream. Any lost or excessively delayed packets cannot be recovered. Bandwidth capacity management can be employed to design the link capacities of network 100 to meet the requirements of various services (such as VoIP) as efficiently as possible. However, there is no guarantee that during some period of peak traffic, available bandwidth will not be overutilized.

Another mechanism that helps smooth out problems during periods of peak network 100 usage are buffers. Buffers normally hold a finite amount of bandwidth so that traffic can be delayed around momentary bursts or peaks in utilization. However, as stated earlier, delayed VoIP packets may as well be discarded. QOS can supplement bandwidth management by adding intelligence when determining which packets are to be dropped during momentary peaks, which packets are to be placed in a buffer, and which packets are to be forwarded immediately. Accordingly, QOS becomes a tool that supplements good bandwidth management during momentary peaks. QOS is not an all-encompassing solution to capacity management as, even in the presence of QOS, it is necessary to manage bandwidth capacity.

QOS allows differentiation of traffic. Traffic can be divided into different classes, with each class being handled differently by network 100. Illustratively, these different classes include at least a high class of service and a low class of service. QOS allows the capability of ensuring that some traffic will rarely, if ever, get dropped. QOS also provides a mechanism for determining a percentage risk or likelihood that packets from a certain class of traffic will be dropped. The high class of service has little risk of getting dropped and the low class of service has the highest risk of getting dropped. The QOS mechanisms enforce this paradigm by classifying traffic and providing preferential treatment to higher classes of traffic. Therefore, bandwidth capacity must be managed in a manner so as to never or only minimally impact the highest class of traffic. Lower classes may be impacted or delayed based on how much bandwidth is available.

In general, bandwidth on network 100 may be managed to meet service level agreement (SLA) requirements for one or more QOS classes. An SLA is a contract between a network service provider and a customer or user that specifies, in measurable terms, what services the network service provider will furnish.

Illustrative metrics that SLAs may specify include:

A percentage of time for which service will be available;

A number of users that can be served simultaneously;

Specific performance benchmarks to which actual performance will be periodically compared;

A schedule for notification in advance of network changes that may affect users;

Help desk response time for various classes of problems;

Dial-in access availability; and

Identification of any usage statistics that will be provided.

Network 100 is designed to provide reliable communication services in view of real world cost constraints. In order to provide a network 100 where user traffic is never dropped, it would be necessary to provide one bit of traffic in core layer 102 for every bit of traffic in edge layer 104. Since it is impossible to determine where each individual user would send data, one would need to assume that every user could send all of their bandwidth to all other users. This assumption would result in the need for a large amount of bandwidth in core layer 102. However, if it is predicted that five individual users that each have a T1 of bandwidth apiece will only use, at most, a total of T1 of bandwidth simultaneously, this prediction may be right most of the time. During the time intervals where this prediction is wrong, the users will be unhappy. Bandwidth management techniques seek to determine what the “right” amount of bandwidth is. If one knew exactly how much bandwidth was used at every moment in time, one could statistically determine how many time intervals would result in lost data and design the bandwidth capacity of network 100 to meet a desired level of statistical certainty. Averaged samples may be utilized to provide this level of statistical certainty.

At first glance, it might appear that a network interface could be employed to monitor bandwidth utilization of network 100 over time. If the interface detects an increase in utilization, more bandwidth is then added to network 100. One problem with this approach is that, if a portion of network 100 fails, the required bandwidth may double or triple. If four different classes of traffic are provided including a higher priority class and three lower priority classes, and if too much higher priority traffic is rerouted around a failed link, this higher priority traffic will “starve out” traffic from the three lower priority classes, preventing the traffic from being sent to a desired destination using network 100. Therefore, total capacity and capacity within each class may be managed.

Traffic patterns in core layer 102 differ from patterns in edge layer 104 because routing and not customer utilization determine the load on a path in core layer 102. If a node of core layer 102 fails, such as a router of routers 130-132, then traffic patterns will change. In edge layer 104, traffic patterns usually change due to user driven reasons, i.e. behavior patterns.

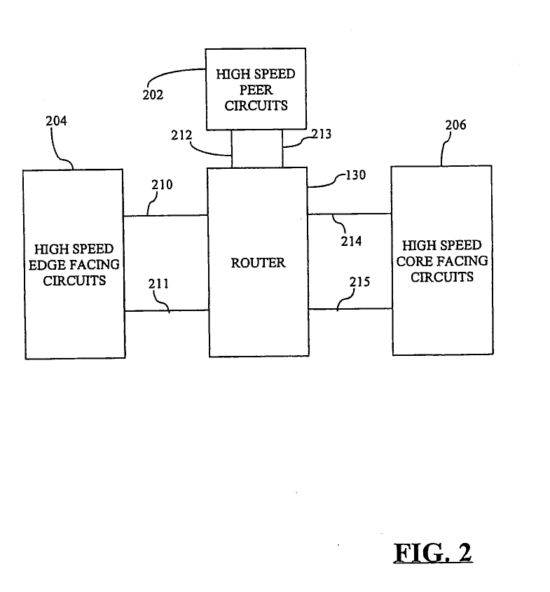

FIG. 2 is a block diagram depicting illustrative traffic flow for the network of FIG. 1. More specifically, traffic flow for router 130 (FIGS. 1 and 2) of core layer 102 is illustrated. Router 130 may be conceptualized as a core node. Each link 210, 211, 212, 213, 215, 215 represents aggregated user traffic arriving from an upstream device, a downstream device, or a peer device. For example, links 210 and 211 represent aggregated user traffic from high speed edge facing circuits 204. High speed edge facing circuits receive traffic originating from edge layer 104 (FIG. 1). Links 214 and 215 (FIG. 2) represent aggregated user traffic from high speed core facing circuits 206. High speed core facing circuits 206 and high speed peer circuits 202 receive traffic from other routers in core layer 102 (FIG. 1) such as routers 131 and 132.

The traffic flow depicted in FIG. 2 is based on the current state of network 100 (FIG. 1). Monitoring network 100 with an appropriate network usage interface will not provide enough information to enable a determination as to whether or not there would be enough capacity during a network failure or a traffic routing change due to an endpoint failure. For example, if a PSTN gateway is connected to edge layer 104 (FIG. 1) and that gateway fails, then all of the traffic destined for the PSTN will take a different route to a different PSTN gateway.

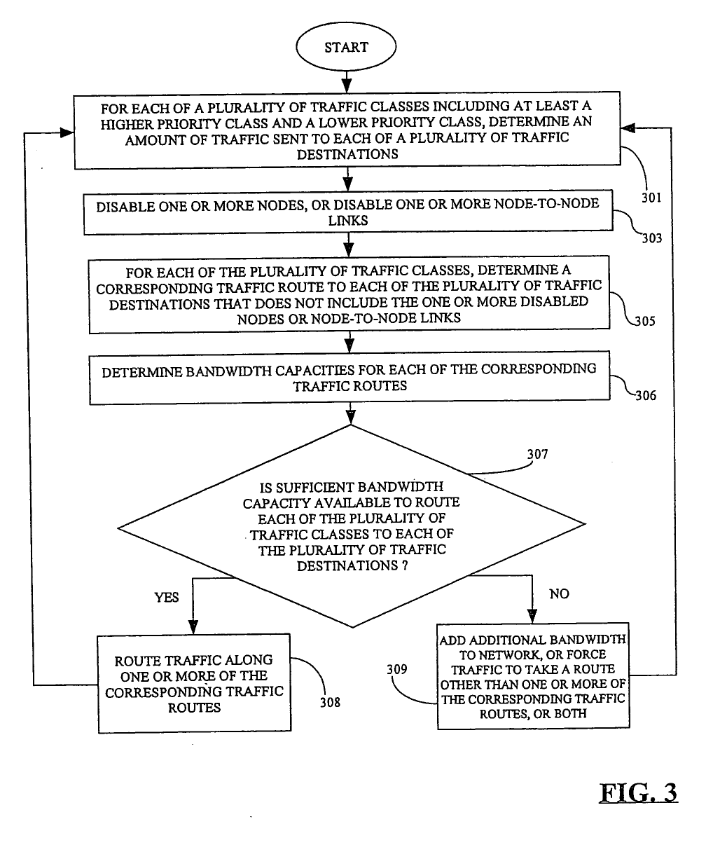

FIG. 3 is a flowchart setting forth illustrative methods for managing the bandwidth capacity of a network that includes a plurality of traffic destinations and a plurality of nodes. One example of such a network is network 100, previously described in connection with FIG. 1. The network could, but need not, be a Multi-Protocol Label Switching (MPLS) network. The procedure of FIG. 3 commences at block 301 where, for each of a plurality of traffic classes including at least a higher priority class and a lower priority class, an amount of traffic sent to each of a plurality of traffic destinations is determined. The plurality of traffic destinations may each represent a node including any of the routers 110-116 shown in FIG. 1 where each of these routers represents a provider edge (PE) router. The operation performed at block 301 (FIG. 3) determines how much traffic will be routed from each individual PE router 110-116 (FIG. 1) to every other PE router 110-116 in network 100.

At block 303 (FIG. 3), one or more nodes are disabled, or one or more node-to-node links are disabled. For example, each node may represent a specific router 110-116, 120-127, or 130-132 in network 100. This disabling is intended to model failure of one or more routers, links between routers, or various combinations thereof. Next, for each of the plurality of traffic classes, a corresponding traffic route to each of the plurality of traffic destinations and not including the one or more disabled nodes or disabled node-to-node links is determined (block 305). The amount of traffic that will be rerouted (block 301), as well the routes the traffic will follow (block 305), may be represented using matrices, spreadsheets, or both.

Bandwidth capacities for each of the corresponding traffic routes are determined to ascertain whether or not sufficient bandwidth capacity is available to route each of the plurality of traffic classes to each of the plurality of traffic destinations (block 307). If sufficient bandwidth capacity is not available, additional bandwidth is added to the network, or traffic is forced to take a route other than one or more of the corresponding traffic routes, or both (block 309).

Considering block 305 in greater detail, two types of information from each PE router 110-116 (FIG. 1) are employed to determine how traffic will be routed. The first type of information is a list of all open shortest path first (OSPF) neighbors for each PE router 110-116. The second type of information is an OSPF weight from each router to each OSPF neighbor. After these two types of information are obtained, the procedure of FIG. 3 may execute an OSPF algorithm for determining the best route in network 100 (FIG. 1) from every PE router 110-116 to every other PE router 110-116. This information may be gathered via SNMP from an OSPF management information base (MIB) or via other means.

OSPF is a router protocol used within larger autonomous system networks. OSPF is designated by the Internet Engineering Task Force (IETF) as one of several Interior Gateway Protocols (IGPs). Pursuant to OSPF, a router or host that obtains a change to a routing table or detects a change in the network immediately multicasts the information to all other routers or hosts in the network so that all will have the same routing table information. A router or host using OSPF does not multicast an entire routing table, but rather sends only a portion of the routing table that has changed, and only when a change has taken place.

OSPF allows a user to assign cost metrics to a given host or router so that some paths or links are given preference over other paths or links. OSPF supports a variable network subnet mask so that a network can be subdivided into two or more smaller portions. Rather than simply counting a number of node to node hops, OSPF bases its path descriptions on “link states” that take into account additional network information.

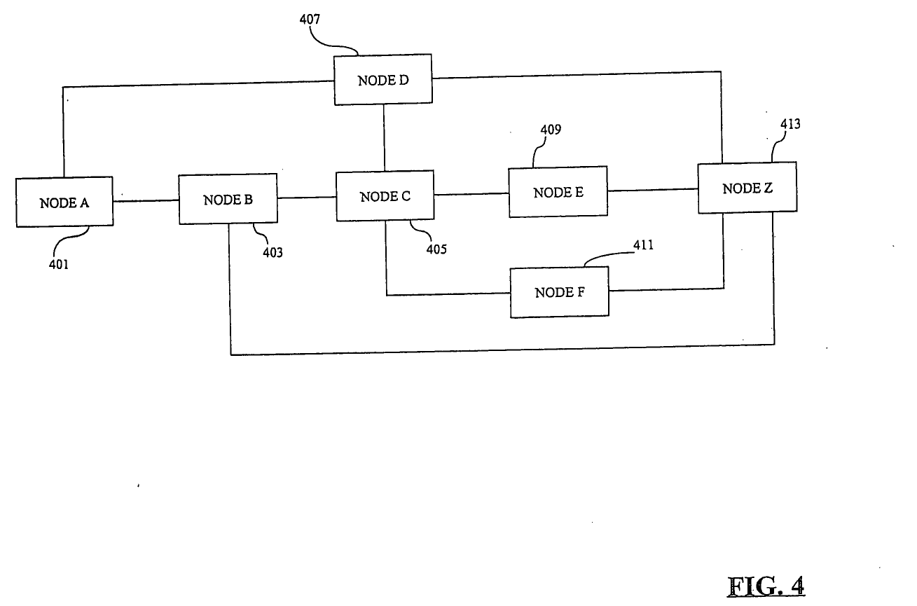

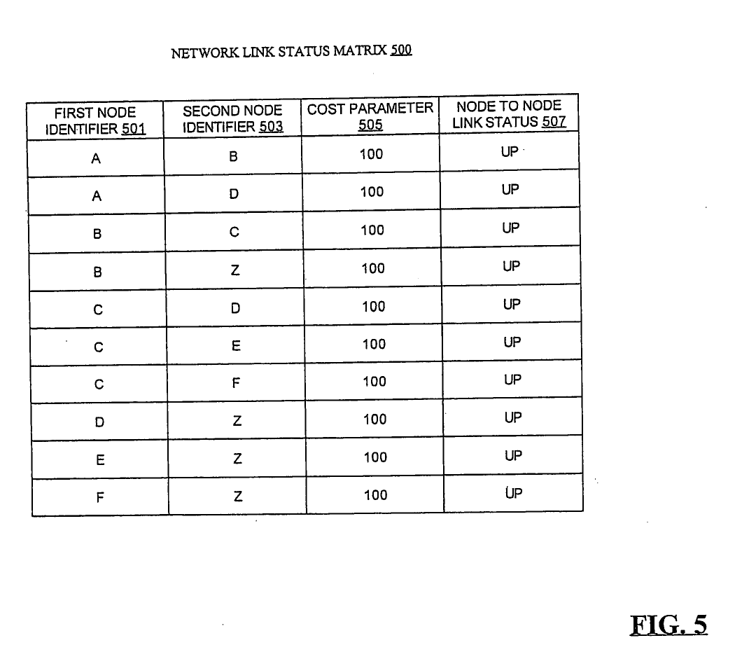

FIG. 4 is a block diagram showing an illustrative communications network on which the procedure of FIG. 3 may be performed to generate a network topology matrix 500 as shown in FIG. 5. The network of FIG. 4 includes seven interconnected nodes denoted as Node A 401, Node B 403, Node C 405, Node D 407, Node E 409, Node F 411, and Node Z 413. These nodes 401, 403, 405, 407, 409, 411, 413 may each be implemented using one or more routers 110-116, 120-127, 130-132 shown in FIG. 1. For each of the links or interconnections between nodes 401, 403, 405, 407, 409, 411, and 413 of FIG. 4, network topology matrix 500 (FIG. 5) indicates the status of the link or interconnection. If a link or interconnection is functional, the link or interconnection is said to be “up”. If a link or interconnection is disabled or not functional, the link or interconnection is said to be “down”. For example, network topology matrix 500 shows that all links are up, including a link between Node A 401 and Node B 403, and a link between Node A 401 and Node D 407.

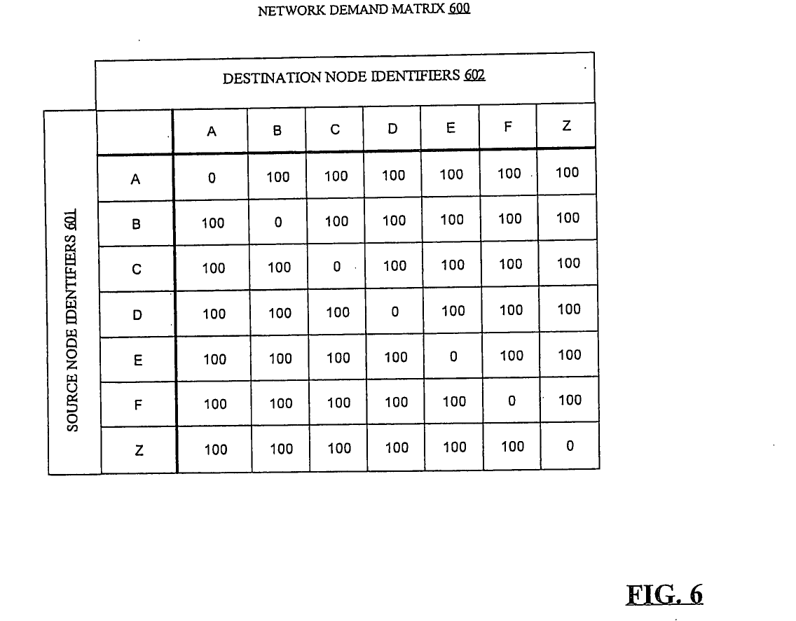

FIG. 6 shows an exemplary network demand matrix 600 for the network of FIG. 4. For each of a plurality of source node—destination node combinations, network demand matrix 600 shows a relative or absolute amount of bandwidth demand associated with a communications link including the source node and destination node. Source nodes are identified using source node identifiers 601, and destination nodes are identified using destination node identifiers 602. For example, Node A 401 is identified using a source node identifier of “A” and a destination node identifier of “A”. Similarly, Node D 407 is identified using a source node identifier of “D” and a destination node identifier of “D”. In the present example, a link between source node D and destination node A presents a bandwidth demand of 100, representing 100 megabytes per second. Similarly, a link between destination node A and source node D presents a bandwidth demand of 100 megabytes per second.

Once network topology matrix 500 (FIG. 5) and network demand matrix 600 (FIG. 6) are populated, the procedure of FIG. 3 (block 301) determines possible routes that data will take in order to traverse from each of a plurality of source nodes to each of a plurality of destination nodes. The source nodes and the destination nodes may each comprise a PE router selected from PE routers 110-116 (FIG. 1). These possible routes may, but need not, be stored in the form of a path selection matrix.

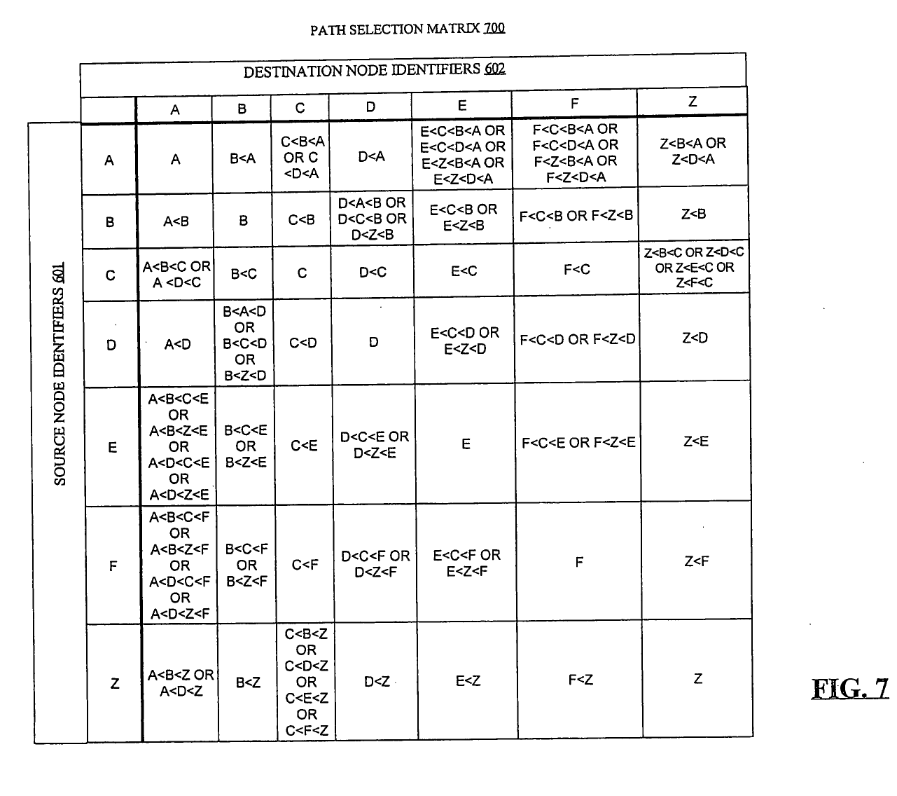

FIG. 7 shows an exemplary path selection matrix 700 for the network of FIG. 4. For each of a plurality of source node—destination node combinations, path selection matrix shows zero or more possible paths linking the destination node with the source node. Source nodes are identified using source node identifiers 601, and destination nodes are identified using destination node identifiers 602. For example, there is only one possible path linking Node A 401 (FIG. 4) to Node B 402, wherein this path is represented in path selection matrix 700 (FIG. 7) as B<A. On the other hand, there are two possible paths linking Node B 402 (FIG. 4) with node F 406, and these paths are denoted in path selection matrix 700 (FIG. 7) as F<C<B and F<Z<B.

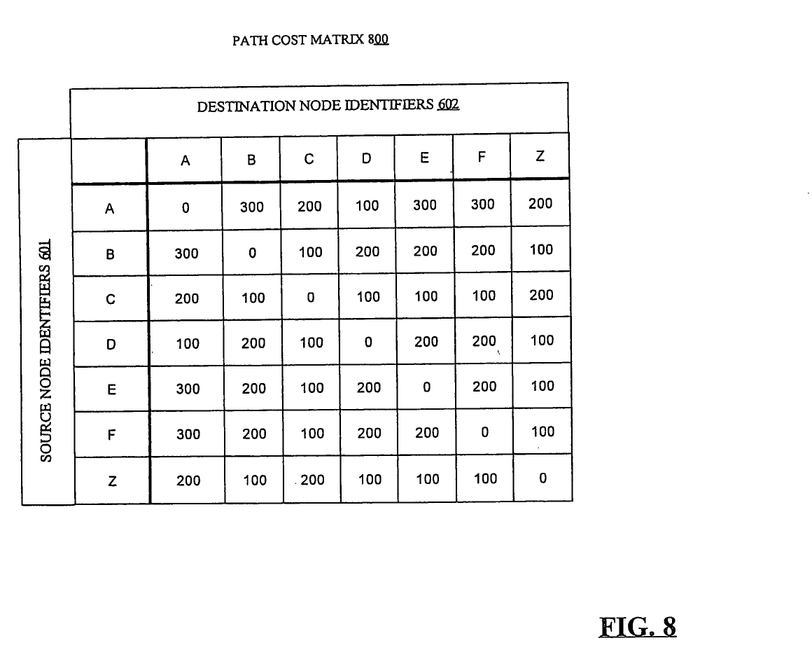

FIG. 8 is a path cost matrix 800 showing a relative or absolute bandwidth cost associated with sending traffic between each of a plurality of source nodes and destination nodes. Traffic is sent between each of the plurality of source nodes and destination nodes along one or more paths as set forth in path selection matrix 700. Accordingly, the cost of sending traffic from a specified source node to a specified destination node may be determined by considering the costs of sending traffic along all possible paths between the specified source node and the specified destination node, wherein these possible paths have been identified in path selection matrix 700. However, one difficulty with populating path cost matrix 800 (FIG. 8) is that it is difficult to determine how much traffic goes from every node 401-413 to every other node 401-413 of FIG. 4 (or, equivalently, how much traffic goes from every PE router 110-116 of FIG. 1 to every other PE router), especially on a per class basis.

Any of several possible techniques may be used to populate path cost matrix 800 of FIG. 8. For example, in some networks, each PE router 110-116 (FIG. 1) has a unique label associated with a path or link towards that PE router. Many routers support a feature for determining the number of packets that are transmitted for each of a plurality of labels. This feature is not uniform from router manufacturer to router manufacturer and, as such, it is currently not possible to obtain a list of label paths and associate them with a far end PE router and an amount of traffic sent to that router. Additionally this information is not available on a per class basis.

A second technique for populating path cost matrix 800 (FIG. 8) is by implementing a Netflow or Cflowd command to determine traffic flow on various routes from a given PE router to all other PE routers. Such information may have to be collated manually and then associated with an appropriate label. Finally, a third technique is to leverage an existing tool, such as Deep Packet Inspection, to provide data for populating path cost matrix 800 of FIG. 8.

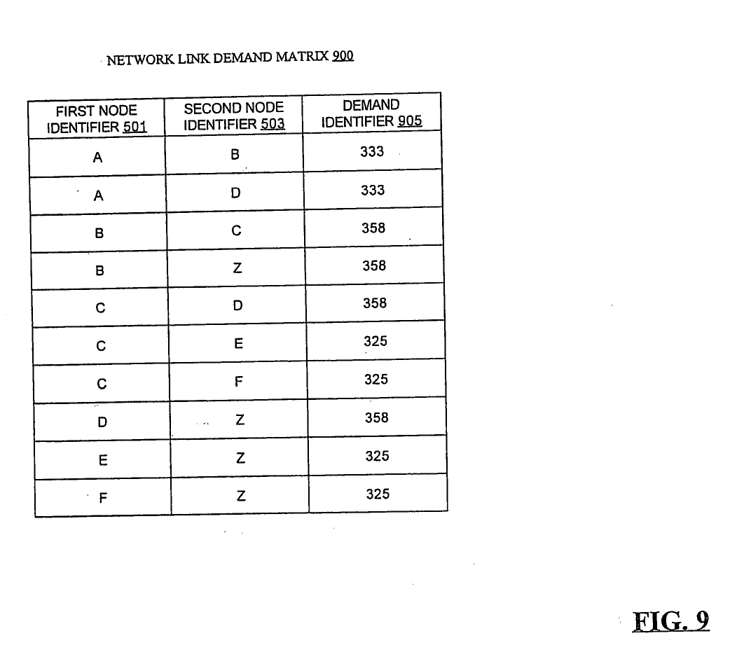

FIG. 9 is a network link demand matrix 900 showing bandwidth demand for each of a plurality of source node to destination node links as determined using path cost matrix 800 (FIG. 8) and path selection matrix 700 (FIG. 7). Returning to FIG. 9, network link demand matrix 900 associates each of a plurality of first node identifiers 501, representing source nodes, with each of a plurality of second node identifiers 503, representing destination nodes, and each of a plurality of demand identifiers 905. Demand identifiers 905 each identify an absolute or relative amount of bandwidth demand corresponding to a given source node to destination node link. For example, a source node C to destination node E link is associated with a bandwidth demand of 325 megabytes per second.

Using network link status matrix 500 (FIG. 5) and network demand matrix 600 (FIG. 6), the procedure of FIG. 3 may perform block 301 by using an offered load to calculate a bandwidth load on all of the core routers 130-132 (FIG. 1). After an initial run, this calculation can be repeated for an offered load in each of a plurality of classes to determine a “per class” loading on core routers 130-132. The results of this per class loading calculation on core routers 130-132 may be presented in the form of a network link demand matrix 900 for each of a plurality of classes. This offered load considers measurements of bandwidth capacities for each of a plurality of traffic routes to ascertain whether or not sufficient bandwidth capacity is available to route each of the plurality of traffic classes to each of the plurality of traffic destinations.

Once the procedure of FIG. 3 (block 301) is used to generate path selection matrix 700 (FIG. 7), path cost matrix 800 (FIG. 8) and network link demand matrix 900 (FIG. 9), blocks 303-309 of FIG. 3 can be repeated iteratively. This iterative repetition may be performed by failing different nodes in the core during each successive iteration, wherein each node represents any of routers 130-132 (FIG. 1). This will result in redistribution of the traffic load, indicating where capacity would be needed during network failure. Optionally, the procedure of FIG. 3 can be repeated iteratively on a per class basis.

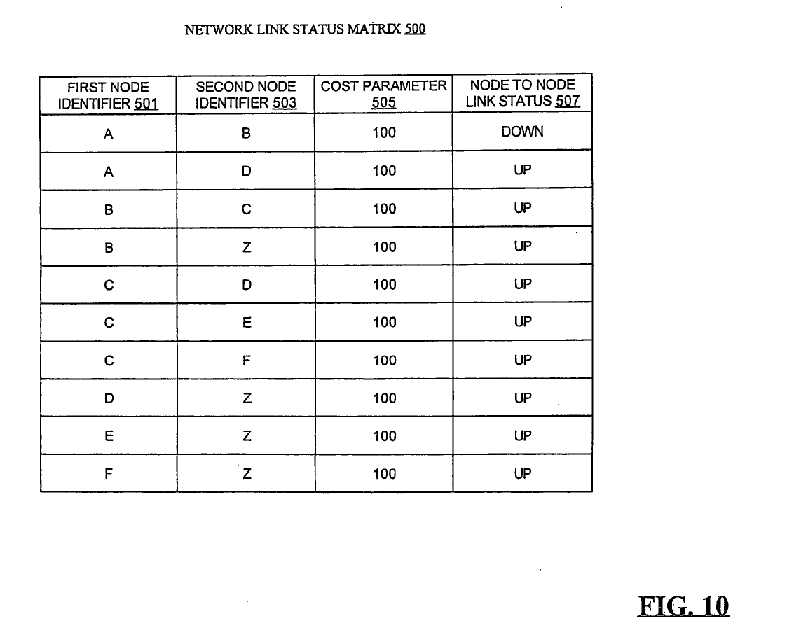

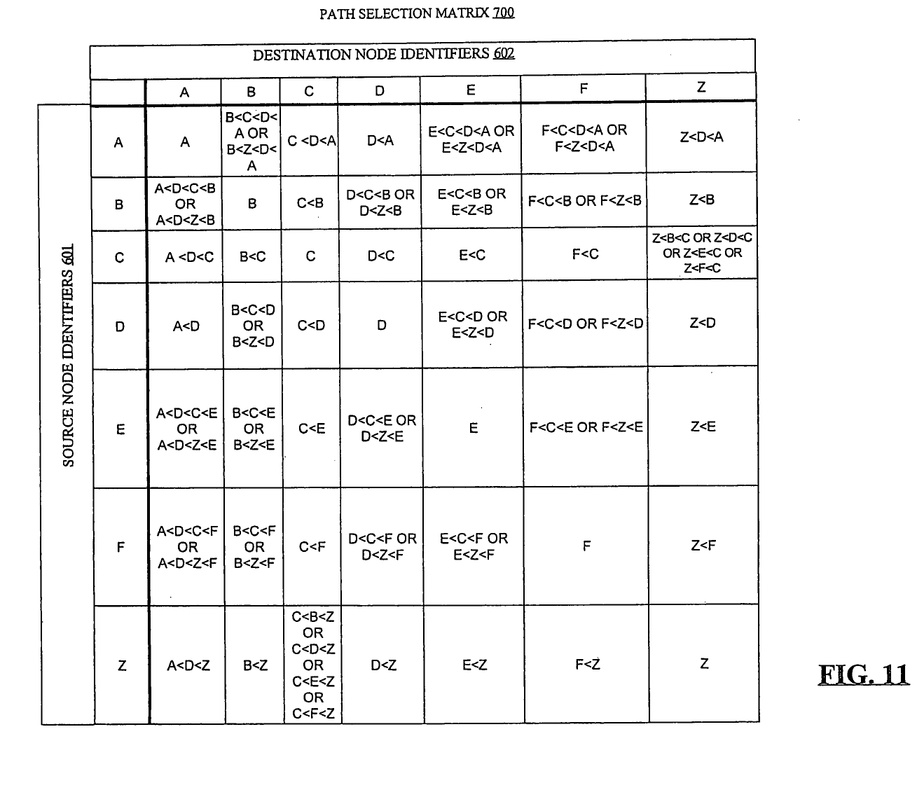

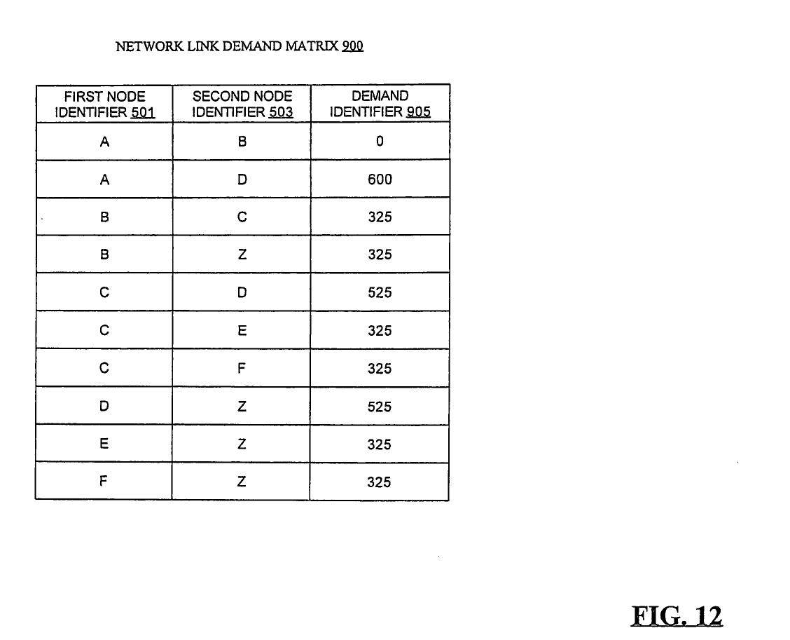

For illustrative purposes, assume that a Node A 401 (FIG. 4) to Node B 402 link is disabled at block 303 (FIG. 3). Network link status matrix 500 of FIG. 5 is updated in FIG. 10 to show that this link is “down”, whereas all other links have a node-to-node link status 507 of “up”. Accordingly, upon execution of the procedure described in blocks 303-309 of FIG. 3, path selection matrix 700 of FIG. 7 is updated as shown in FIG. 11 to eliminate any paths that include a Node A to Node B link. Likewise, network link demand matrix 900 of FIG. 9 is updated in FIG. 12 to show a demand identifier 905 of zero for the Node A 401 (FIG. 4) to Node B 402 link. Demand identifier 905 (FIG. 12) sets forth relative or actual bandwidth demand for each of a plurality of node-to-node links. Since the Node A to Node B link is down, the bandwidth demands for other node-to-node links are updated. For example, bandwidth demand for a Node A 401 (FIG. 1) to Node D 404 link has almost doubled from 333 megabytes per second (FIG. 9) to 600 megabytes per second (FIG. 12) as a result of the Node A to Node B link being disabled.

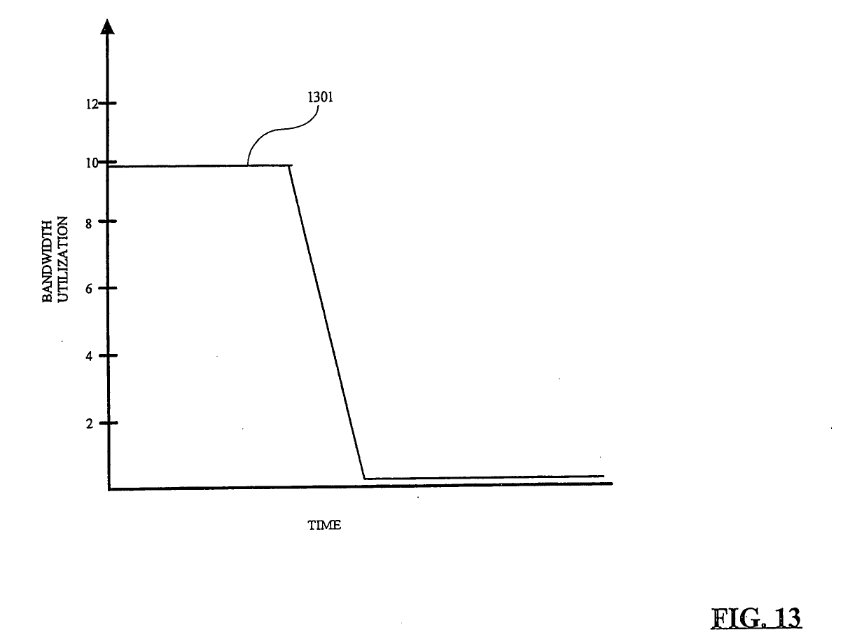

If the procedure of FIG. 3 is executed periodically, and data point maxima for each core router 130-132 (FIG. 1) are plotted, a trend line can be developed to determine a forecast for adding additional bandwidth to core layer 102. The procedure of FIG. 3 may, but need not, be executed by sampling data from any of routers 110-116, 120-127 and 130-132 (FIG. 1) at periodic or regular intervals. For example, a router polling mechanism may take a first measurement and then at a fixed sample interval take a second measurement. The polling mechanism uses the difference between the first and second measurements to determine a utilization value for that sample interval. Depending on the length selected for the sample interval, it is possible to misrepresent traffic peaks and valleys. The sample utilization graph of FIG. 13 illustrates the manner in which traffic peaks and valleys may be misrepresented in some sampling situations.

Referring to FIG. 13, line 1301 represents 5 data points each having a value of 10 and 5 data points each having a value of 0. Line 703 represents 10 data points of 5. If all of these data points occurred during one sample interval, both samples would indicate an average of 5. If the network used this data and assumed that 5 was the correct number, then the network would fail half of the time. One method for avoiding this problem is to acquire instantaneous data points, although alternative methods are also possible.

Various concepts may be employed to avoid the necessity of acquiring instantaneous data points. For example, individual user demand for bandwidth on a data communications network does not remain constant and continuous over long periods of time. Rather, many users exhibit short periods of heavy bandwidth demand interspersed with longer periods of little or no demand. This pattern of user activity generates data traffic that is said to be “bursty”. Once many circuits with bursty traffic are aggregated, the bursts tend to disappear and traffic volume becomes more uniform as a function of time. This phenomenon occurs because traffic for a first user does not always peak at the same moment in time as traffic from a second user. If the first user is peaking, the second user may remain idle. As more and more users are added, the peaks tend to smooth out. Therefore, the momentary bursts will be eliminated or smoothed out to some extent.

As soon as traffic arrives at a router, the traffic is forwarded. If the arrival rate of the traffic is less than the forwarding rate of the device, queueing should not be applied. The only time queuing would be necessary is if two packets arrive at substantially the same exact moment in time. Since customer facing router circuits normally operate at much slower speed than core router circuits, it should appear to the user that they have complete use of the entire circuit, and even two simultaneously arriving packets should not experience queueing. In order to determine if user traffic exceeded core traffic, the average and maximum queue depth can be monitored. Normally this number should be zero or very close to it. If there is queuing, then the line rate has been exceeded. If the average or maximum queue depth is increasing then additional capacity should be added. The queue depth should always be close to zero.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of managing the bandwidth capacity of a network that includes a plurality of traffic destinations, a plurality of nodes, and a plurality of node-to-node links, the method comprising:
determining an amount of traffic sent to each of the plurality of traffic destinations for each of a plurality of traffic classes including at least a higher priority class and a lower priority class;
disabling one or more nodes, or disabling one or more node-to-node links;
determining, for each of the plurality of traffic classes, a corresponding traffic route to each of the plurality of traffic destinations and not including the one or more disabled nodes or disabled node-to-node links;
determining bandwidth capacities for each of the corresponding traffic routes to ascertain whether or not sufficient bandwidth capacity is available to route each of the plurality of traffic classes to each of the plurality of traffic destinations.

2. The method of claim 1 further comprising adding additional bandwidth to the network if sufficient bandwidth capacity is not available to route each of the plurality of traffic classes to each of the plurality of traffic destinations.

3. The method of claim 1 further comprising determining an alternate route other than the corresponding traffic route for one or more of the plurality of traffic classes if sufficient bandwidth capacity is not available to route each of the plurality of traffic classes to each of the plurality of traffic destinations.

4. The method of claim 1 further comprising routing traffic from a traffic source to a traffic destination of the plurality of traffic destinations by determining a first cost of routing traffic along a first path from the traffic source to the traffic destination and a second cost of routing traffic along a second path from the traffic source to the traffic destination, and routing traffic along the first path if the first cost is lower than the second cost.

5. The method of claim 4 wherein the first path includes a first sequence of router to router links and the second path includes a second sequence of router to router links.

6. The method of claim 5 further comprising applying a quality of service (QOS) constraint to a traffic class of the plurality of traffic classes, wherein the QOS constraint specifies a risk or a likelihood that a data packet corresponding to that traffic class will be dropped.

7. The method of claim 6 wherein the plurality of traffic classes comprises one or more of a first traffic class for voice over internet protocol (VoIP) data and a second traffic class for file transfer protocol (FTP) data.

8. A computer program product for managing the bandwidth capacity of a network that includes a plurality of traffic destinations, a plurality of nodes, and a plurality of node-to-node links, the computer program product comprising a storage medium readable by a processing circuit and storing instructions for execution by the processing circuit for facilitating a method comprising:
determining an amount of traffic sent to each of the plurality of traffic destinations for each of a plurality of traffic classes including at least a higher priority class and a lower priority class;
disabling one or more nodes, or disabling one or more node-to-node links;
determining, for each of the plurality of traffic classes, a corresponding traffic route to each of the plurality of traffic destinations and not including the one or more disabled nodes or disabled node-to-node links;
determining bandwidth capacities for each of the corresponding traffic routes to ascertain whether or not sufficient bandwidth capacity is available to route each of the plurality of traffic classes to each of the plurality of traffic destinations wherein, if sufficient bandwidth capacity is not available, additional bandwidth is added to the network, or traffic is forced to take a route other than one or more of the corresponding traffic routes, or both.

9. The computer program product of claim 8 further comprising instructions for incorporating additional bandwidth into the network if sufficient bandwidth capacity is not available to route each of the plurality of traffic classes to each of the plurality of traffic destinations.

10. The computer program product of claim 8 further comprising instructions for determining an alternate route other than the corresponding traffic route for one or more of the plurality of traffic classes if sufficient bandwidth capacity is not available to route each of the plurality of traffic classes to each of the plurality of traffic destinations.

11. The computer program product of claim 8 further comprising instructions for routing traffic from a traffic source to a traffic destination of the plurality of traffic destinations by determining a first cost of routing traffic along a first path from the traffic source to the traffic destination and a second cost of routing traffic along a second path from the traffic source to the traffic destination, and routing traffic along the first path if the first cost is lower than the second cost.

12. The computer program product of claim 11 wherein the first path includes a first sequence of router to router links and the second path includes a second sequence of router to router links.

13. The computer program product of claim 12 further comprising instructions for applying a quality of service (QOS) constraint to a traffic class of the plurality of traffic classes, wherein the QOS constraint specifies a risk or a likelihood that a data packet corresponding to that traffic class will be dropped.

14. The computer program product of claim 13 wherein the plurality of traffic classes comprises one or more of a first traffic class for voice over internet protocol (VoIP) data and a second traffic class for file transfer protocol (FTP) data.

15. A system for managing the bandwidth capacity of a network that includes a traffic destination, a plurality of nodes, and a plurality of node-to-node links, the system including:
a monitoring mechanism for determining an amount of traffic sent to the traffic destination for each of a plurality of traffic classes including at least a higher priority class and a lower priority class;
a disabling mechanism, operably coupled to the monitoring mechanism, and capable of selectively disabling one or more nodes or one or more node-to-node links;
a processing mechanism, operatively coupled to the disabling mechanism and the monitoring mechanism, and capable of determining a corresponding traffic route to the traffic destination for each of the plurality of traffic classes, such that the corresponding traffic route does not include the one or more disabled nodes or disabled node-to-node links;
wherein the monitoring mechanism determines bandwidth capacities for each of the corresponding traffic routes, the processing mechanism ascertains whether or not sufficient bandwidth capacity is available to route each of the plurality of traffic classes to the traffic destination and, if sufficient bandwidth capacity is not available, additional bandwidth is added to the network, or the processing mechanism forces traffic to take a route other than one or more of the corresponding traffic routes.

16. The system of claim 15 wherein additional bandwidth is incorporated into the network if sufficient bandwidth capacity is not available to route each of the plurality of traffic classes to each of the plurality of traffic destinations.

17. The system of claim 15 wherein the processing mechanism is capable of determining an alternate route other than the corresponding traffic route for one or more of the plurality of traffic classes if sufficient bandwidth capacity is not available to route each of the plurality of traffic classes to each of the plurality of traffic destinations.

18. The system of claim 15 wherein the processing mechanism is capable of routing traffic from a traffic source to a traffic destination of the plurality of traffic destinations by determining a first cost of routing traffic along a first path from the traffic source to the traffic destination and a second cost of routing traffic along a second path from the traffic source to the traffic destination, and routing traffic along the first path if the first cost is lower than the second cost.

19. The system of claim 18 wherein the first path includes a first sequence of router to router links and the second path includes a second sequence of router to router links.

20. The system of claim 15 wherein the processing mechanism is capable of applying a quality of service (QOS) constraint to a traffic class of the plurality of traffic classes, wherein the QOS constraint specifies a risk or a likelihood that a data packet corresponding to that traffic class will be dropped.

21. The system of claim 20 wherein the plurality of traffic classes comprises one or more of a first traffic class for voice over internet protocol (VoIP) data and a second traffic class for file transfer protocol (FTP) data.

22. The system of claim 15 wherein the network is capable of implementing Multi-Protocol Label Switching (MPLS).
